(19) United States
(12) Patent Application Publication
(10) Pub. No.: US 2009/0242354 A1
(43) Pub. Date: Oct. 1, 2009

(54) COIN DISCRIMINATING DEVICE

(75) Inventors: Satoshi Miyauchi, Gifu (JP); Takehiko Nara, Osaka (JP); Tooru Ueki, Osaka (JP); Kouji Ikeda, Aichi (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/303,325

(22) PCT Filed: Jul. 10, 2007
(86) PCT No.: PCT/JP2007/063708

§ 371 Date: Dec. 3, 2008

(30) Foreign Application Priority Data
Jul. 18, 2006 (JP) 2006-195252
Apr. 18, 2007 (JP) 2007-108898

(51) Int. Cl. G07D 5/08

(52) U.S. Cl. 194/317

(57) ABSTRACT

A coin discriminating device has a detecting part, a first switching part, a storage part, and a control part. The detecting part has a first sensor including a pair of coils, and an oscillating circuit, and is supplied with voltage from a power source, and in addition, outputs a detection signal varied by a coin passing between the coils. The first switching part switches magnetic connection of the coils between an in-phase connection and a reversed-phase connection a plurality of times while the coin passes between the coils. The control part compares the detection signal from the detecting part and a reference signal stored in the storage part so as to determine authentication and a denomination of the coin.

This application is a U.S. national phase application of PCT international application PCT/JP2007/063708.

### TECHNICAL FIELD

The present invention relates to a coin discriminating device mounted on a vending machine or the like.

### BACKGROUND ART

FIG. 21 is a front perspective diagram showing a schematic configuration of a conventional coin discriminating device. This coin discriminating device has housing 1, slot 3, passage 4, three sensors 5, 6 and 7, gate 8, return passage 9, sorting passage 10, discriminating part 11, and storage cylinders 12. Slot 3 for accepting coin 2 is provided at an upper part of housing 1, and passage 4 is connected to slot 3 and is provided so as to be inclined downward. Sensors 5, 6, 7 are provided on a side wall of passage 4. Gate 8 is provided at an end of passage 4. Return passage 9 is connected to one side of gate 8, and sorting passage 10 is connected to another side of gate 8. Coin 2 sorted by sorting passage 10 is stored in one of storage cylinders 12. Outputs of sensors 5, 6, 7 are supplied to discriminating part 11.

Operation of the coin discriminating device configured as mentioned above is described below. Coin 2 dropped into slot 3 rolls on passage 4. Along the way, sensor 5 senses irregularity in the surfaces of coin 2, sensor 6 senses a material of coin 2, and sensor 7 senses a thickness of coin 2. Sensors 5, 6 and 7 transmit sensed characteristics of coin 2 to discriminating part 11. Based on these characteristics, discriminating part 11 discriminates authentication and a denomination of coin 2. Based on the discrimination result, a counterfeit coin is guided from gate 8 to return passage 9. On the other hand, a real coin is guided from gate 8 to sorting passage 10 to be stored in one of storage cylinders 12 by denomination. The above-described coin discriminating device is disclosed, for example, in Patent Document 1 by the inventors of the present application.

Thus, in the conventional coin discriminating device, dedicated sensors 5, 6, 7 are attached independently in order to obtain the characteristics of the irregularity, material and thickness of coin 2. Sensors 5, 6, 7 are installed in order from an upstream side of passage 4, and two of these cannot be installed in the same place. Accordingly, the irregularity, material and thickness of coin 2 are detected independently of each other in different places without associating with each other. Therefore, sensing a correlation between the irregularity, material and thickness of coin 2 at the same site is difficult, and the precise discrimination of coin 2 has limitations.

Patent Document 1: Unexamined Japanese Patent Publication No. 2006-59139

### SUMMARY OF THE INVENTION

The present invention is a coin discriminating device capable of detecting also a correlation of two types of characteristics at the same site of a coin. The coin discriminating device of the present invention has a detecting part, a first switching part, a storage part, and a control part. The detecting part has a first sensor including a pair of coils, and an oscillating circuit, is supplied with voltage from a power source, and outputs a detection signal varied by passing of a coin between the coils. The first switching part switches a magnetic connection of the coils between an in-phase connection and a reversed-phase connection a plurality of times while the coin passes between the coils. The control part compares the detection signal from the detecting part and a reference signal stored in the storage part so as to determine authentication and a denomination of the coin. Thus, since the first switching part switches the magnetic connection of the coils between the in-phase connection and the reversed-phase connection a plurality of times while the coin passes between the coils, the correlation of the plurality types of characteristics at the same site of the coin can be detected.

### BRIEF DESCRIPTION OF DRAWINGS

FIG. 1 is a front perspective view showing a schematic configuration of a coin discriminating device in a first exemplary embodiment of the present invention.

FIG. 2 is a block diagram for simplistically explaining a configuration of a coin discriminating device in each of first to fourth exemplary embodiments of the present invention.

FIG. 3 is a cross-sectional diagram showing a first state of a first sensor making up the coin discriminating device shown in FIG. 2.

FIG. 4 is a cross-sectional diagram showing a second state of the first sensor shown in FIG. 3.

FIG. 5 is a circuit diagram showing a connection configuration between a first switching part and the first sensor shown in FIG. 2.

FIG. 6 is a circuit diagram showing a connection configuration of a third switching part, the first sensor and a capacitor group shown in FIG. 2.

FIG. 7 is an output waveform diagram outputted from the first sensor and a second sensor of the coin discriminating device shown in FIG. 2.

FIG. 8 is a diagram showing the respective waveforms shown in FIG. 7 in an expanded manner, and showing output signal waveforms of the respective parts.

FIG. 9 is a block diagram of the coin discriminating device in the first exemplary embodiment of the present invention.

FIG. 10 is a circuit diagram of a tuning circuit, a detecting circuit and vicinity thereof in FIG. 9.

FIG. 11 is a circuit diagram of an electronic switch, which is one of switches in FIG. 10.

FIG. 12 is a tuning property diagram by difference in material of a coin.

FIG. 13 is a tuning property diagram by difference in thickness of the coin.

FIG. 14 is a cross-sectional diagram of a coin to be discriminated in the second exemplary embodiment of the present invention.

FIG. 15 is a property diagram showing variations of an output voltage of a tuning circuit with respect to a depth from a top surface of the coin shown in FIG. 14.

FIG. 16 is a circuit diagram showing a part of a tuning circuit of the coin discriminating device in the third exemplary embodiment of the present invention.

FIG. 17 is a block diagram of the coin discriminating device in the fourth exemplary embodiment of the present invention.

FIG. 18 is a circuit diagram of an oscillating part in FIG. 17.

FIG. 19 is a diagram showing output waveforms outputted from the first and second sensors of the coin discriminating device and output signal waveforms of respective parts shown in FIG. 17.

FIG. 20 is a circuit diagram showing one example of a buffer circuit applied to the first and fourth exemplary embodiments.

FIG. 21 is a front perspective view showing a schematic configuration of a conventional coin discriminating device.

### DETAILED DESCRIPTION OF PREFERRED EMBODIMENTS

Hereinafter, referring to the drawings, embodiments of the present invention are described. In the respective embodiments, parts similar to those in the preceding embodiment are given the same reference marks, and description may be simplified.

### First Exemplary Embodiment

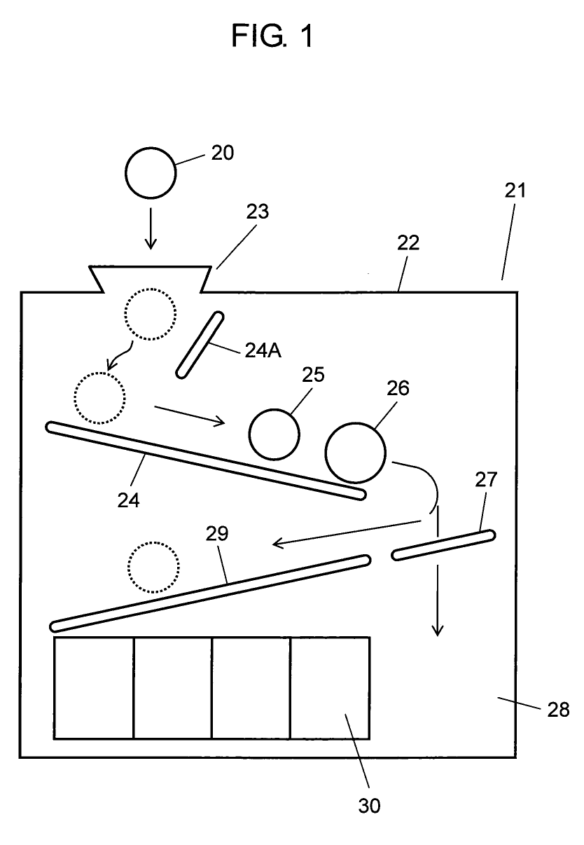

FIG. 1 is a front perspective showing a schematic configuration of coin discriminating device 21 in a first exemplary embodiment of the present invention. Coin discriminating device 21 has housing 22, slot 23, passage 24, first sensor 25 (hereinafter, sensor 25), second sensor 26 (hereinafter, sensor 26), gate 27, return passage 28, sorting passage 29, and storage cylinders 30.

Slot 23 for accepting coin 20 is provided in an upper part of housing 22, and is connected to passage 24 through snubber 24A. Passage 24 is provided downward with an inclination of about 10 to 12 degrees. Sensors 25, 26 are attached to side walls of passage 24 in this order.

For example, the diameter of sensor 25 is 8.3 mm, and the diameter of sensor 26 is 12.5 mm. Sensors 25, 26 are each attached so that a distance from a bottom surface of passage 24 to a center of the each sensor is, for example, 13.25 mm. Moreover, the centers of sensors 25, 26 are separated, for example, by 25.0 mm.

Gate 27 is provided at an end of passage 24 to sort coin 20 in accordance with authenticity. Return passage 28 to which counterfeit coins are guided is connected to one side of gate 27, and sorting passage 29 to which real coins are guided is connected to another side of gate 27. Storage cylinders 30 are connected to sorting passage 29 to store coin 20 sorted by sorting passage 29 by denomination.

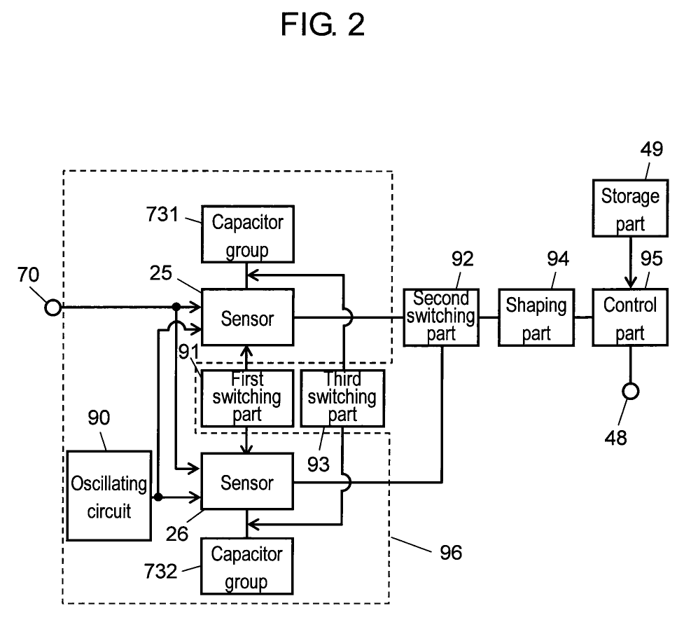

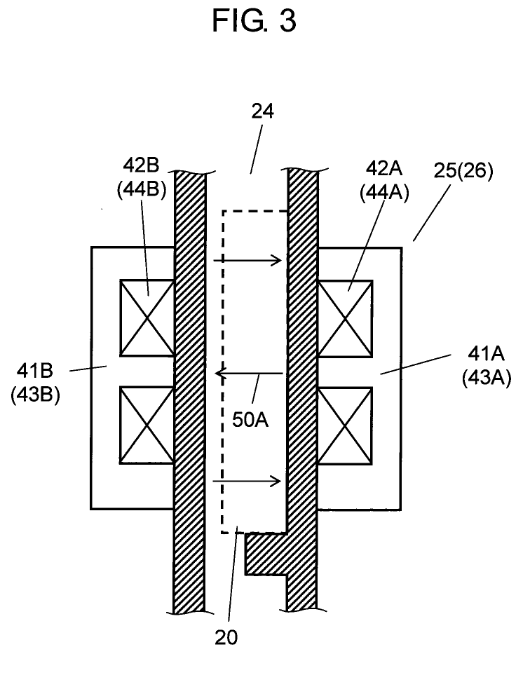

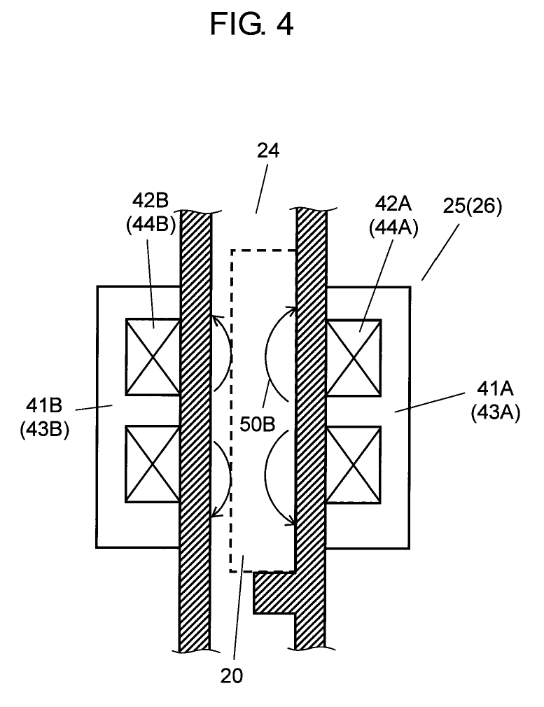

Next, with reference to FIGS. 2 to 4, a description is given, focusing on electric circuitry of coin discriminating device 21. FIG. 2 is a block diagram for simplistically explaining a configuration of coin discriminating device 21. FIGS. 3 and 4 are cross-sectional diagrams of sensors 25, 26.

As shown in FIG. 2, coin discriminating device 21 has sensors 25, 26, oscillating circuit 90, capacitor groups 731, 732, first switching part 91, second switching part 92 and third switching part 93, shaping part 94, control part 95, and storage part 49 as electric circuitry. Sensor 25 and capacitor group 731, sensor 26 and capacitor group 732, and oscillating circuit 90 make up detecting part 96. Storage part 49 in which a reference signal is stored in advance is connected to control part 95. Control part 95 compares a detection signal inputted through shaping part 94 with the reference signal stored in storage part 49 so as to determine the authenticity and the denomination of coin 20.

Next, with reference to FIGS. 3 and 4, sensors 25, 26 are described. Sensor 25 is constructed by winding coils 42A, 42B around ferritic cores 41A, 41B, which are attached so as to be opposed to both walls of passage 24, respectively. Sensor 26 is similarly constructed by winding coils 44A, 44B around ferritic cores 43A, 43B, which are attached so as to be opposed to the both walls of passage 24. Hereinafter, since sensors 25, 26 basically have the same configuration, a description is given, representatively focusing on sensor 25.

A magnetic connection of coil 42A and coil 42B is switched between a series in-phase connection and a series reversed-phase connection by first switching part 91. FIG. 3 shows lines of magnetic force 50A when coil 42A and coil 42B are connected in series and in phase. Lines of magnetic force 50A are outputted in a direction where they penetrate coin 20 in passage 24, so that mainly characteristics of a material of coin 20 are sensed efficiently.

FIG. 4 shows lines of magnetic force 50B when coil 42A and coil 42B are connected in series and in reversed phase. Lines of magnetic force 50B are outputted in a direction where they are limited by coin 20 in passage 24, so that mainly characteristics of irregularity in the surfaces and thickness of coin 20 are sensed efficiently.

That is, detecting part 96 having sensor 25 including the pair of coils 42A, 42B and oscillating circuit 90 outputs a detection signal that are varied by coin 20 passing between coils 42A, 42B. A principle for switching the above-described magnetic connection of coil 42A and coil 42B between the series in-phase connection and the series reversed-phase connection to acquire different pieces of information of coin 20 will be described later.

While coil 42A and coil 42B are connected in series, the connection is not limited to the series connection, but it may be a parallel connection, that is, may be switched between parallel in-phase connection and parallel reversed-phased connection. The series connection results in a large variation, which allows a minute variation to be detected. In contrast, the parallel connection allows a stable output to be sensed.

As described above, sensor 26 has a similar configuration to that of sensor 25, and the diameter of sensor 26 is larger than that of sensor 25. Therefore, by switching the in-phase connection and the reversed-phase connection, sensor 25 can sense material information and irregularity information of coin 20, and sensor 26 can sense material information and thickness information, respectively.

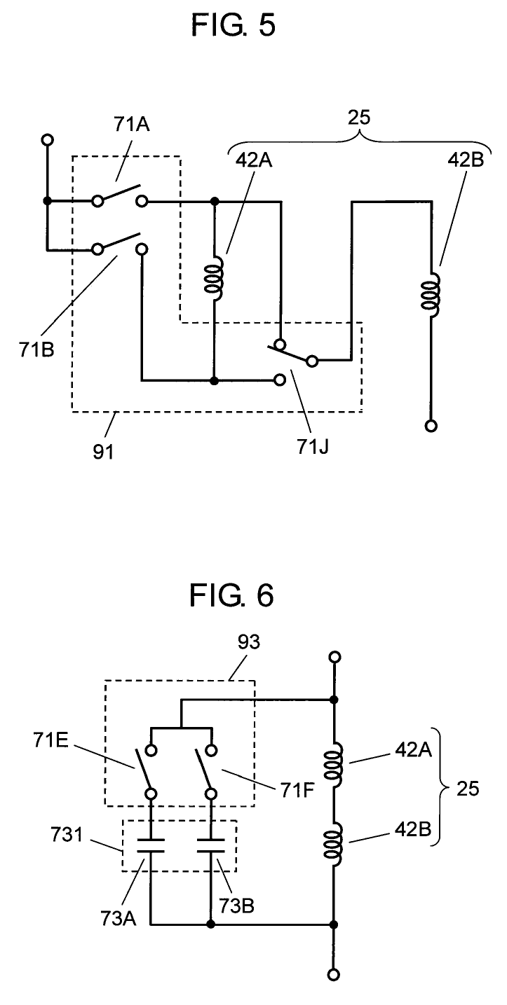

Next, functions of first switching part 91, and third switching part 93 are described. FIG. 5 is a circuit diagram showing a connection configuration of sensor 25 made up of coils 42A, 42B, and switches 71A, 71B and 71J which make up first switching part 91. When switch 71A is shunted and switch 71J is connected to a downside of the figure, coils 42A and 42B are brought into the series in-phase connection. On the other hand, when switch 71B is shunted, and switch 71J is connected to an upside of the figure, coils 42A, 42B are brought into the series reversed-phase connection. In this manner, first switching part 91 switches the magnetic connection of coils 42A, 42B between the series in-phase connection and the series reversed-phased connection. Similarly, first switching part 91 switches the connection of coils 44A, 44B in sensor 26 between the series in-phase connection and the series reversed-phased connection, respectively.

FIG. 6 is a circuit diagram showing a connection configuration of sensor 25 made up of coils 42A, 42B, switches 71E, 71F making up third switching part 93, and capacitors 73A, 73B included in capacitor group 731. For simplification, first switching part 91 is not shown. Third switching part 93 switches capacitors 73A, 73B to be connected to sensor 25. Capacitors 73A, 73B have different capacitances from each other, and are included in capacitor group 731. Since capacitors 73A, 73B are provided independently in this manner, a frequency adjustment for the series in-phase connection and the series reversed-phase connection can be performed easily. Similarly, capacitor group 732 includes two capacitors independently, and third switching part 93 selects and switches the capacitor in accordance with a case of series in-phase connection and a case of series reversed-phase connection of coils 44A, 44B of sensor 26, by which the frequency adjustment is performed. Thus, it is preferable that detecting part 96 has a plurality of capacitors 73A, 73B different in capacitance, and that third switching part 93 switches capacitors 73A, 73B to be connected to sensor 25 or sensor 26. While capacitor groups 731, 732 are made up of the capacitors different in capacitance, alternatively, in capacitor groups 731, 732, a plurality of capacitors having the same capacitance may be used and be connected in series and/or in parallel. That is, third switching part 93 only needs to switch the capacitance connected to sensor 25, 26 to a value suitable for the in-phase connection or the reversed-phase connection, and configurations of capacitor groups 731, 732 are not limited.

While third switching part 93 performs the frequency adjustment by selecting and switching the capacitor in accordance with the case of the series in-phase connection and the case of the series reversed-phase connection of coils 44A, 44B of sensor 26, third switching part 93 may vary a frequency by selecting and switching the capacitor without changing the connection of coils 44A, 44B of sensor 26. That is, the frequency adjustment by third switching part 93 is not limited to operation at the same time as the switching between the in-phase connection and the reversed-phase connection of coils 44A, 44B by first switching part 91. Only varying the frequency allows the plurality of different types of coin characteristics to be detected.

Next, a function of second switching part 92 is described. Second switching part 92 plays a role of switching the detection signal outputted from detecting part 96 including sensors 25, 26 to send to control part 95 through shaping part 94.

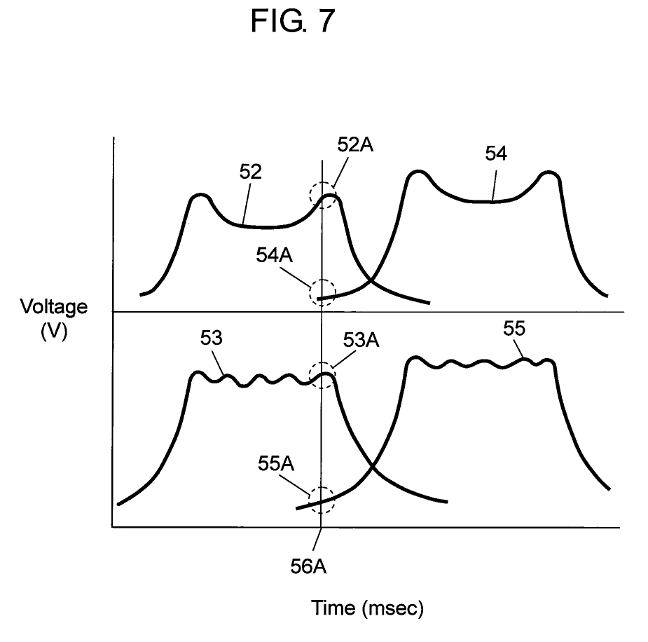

Next, one example of a discriminating method in coin discriminating device 21 configured in this manner is described. FIG. 7 shows envelope waveforms obtained by smoothing detected outputs of sensors 25, 26 when coin 20 passes between coils 42A, 42B, and between coils 44A, 44B. Output waveform 52 is obtained when coils 42A, 42B of sensor 25 are connected in series and in phase, and output waveform 53 is obtained when coils 42A, 42B are connected in series and in reversed phase. Output waveform 54 is obtained when coils 44A, 44B of sensor 26 are connected in series and in phase, and output waveform 55 is obtained when coils 44A, 44B are connected in series and in reversed phase.

In the present embodiment, first switching part 91 switches the connection of coils 42A, 42B to the series in-phase connection or to the series reversed-phase connection. At the same time, third switching part 93 selects the connection of capacitor 73A to sensor 25 or the connection of capacitor 73B to sensor 25 and performs the switching. Therefore, for example, series in-phase connection waveform level 52A indicating the characteristics of the material of coin 20 and series reversed-phase connection waveform level 53A indicating the characteristics of the irregularity of coin 20 at time 56A can be detected almost simultaneously.

Sensor 25 having a diameter of 8.3 mm and sensor 26 having a diameter of 12.5 mm are arranged so that the centers thereof are separated from each other by 25.0 mm. Accordingly, when coin 20 having a diameter of 14.60 mm or more flows between sensors 25, 26, coin 20 is sensed by both sensors 25, 26. Accordingly, sensor 25 can detect series in-phase connection waveform level 52A and series reversed-phase connection waveform level 53A, and sensor 26 can also detect series in-phase connection waveform level 54A and series reversed-phase connection waveform level 55A almost simultaneously.

Switching operation in each of first switching part 91, second switching part 92, and third switching part 93 is performed by control part 95. Alternatively, a dedicated microcomputer that performs switching control may be prepared separately, and first switching part 91, second switching part 92 and third switching part 93 may be switched at predetermined timing.

In this manner, in the present embodiment, first switching part 91 switches coils 44A, 44B to the series in-phase connection or to the series reversed-phase connection. Therefore, in sensor 26, series in-phase connection waveform level 54A indicating the characteristics of the material of coin 20 and series reversed-phase connection waveform level 55A indicating the characteristics of the thickness of coin 20 at time 56A can also be detected almost simultaneously.

Accordingly, at time 56A, the material information and the irregularity information are sensed at the same point of coin 20 from waveform levels 52A and 53A of sensor 25. At the same time as this sensing, the material information and the thickness information of coin 20 are sensed at the same point of coin 20 from waveform levels 54A, 55A of sensor 26. In this manner, mutual information of sensor 25 and sensor 26 can be sensed. Accordingly, coin 20 can be discriminated more precisely.

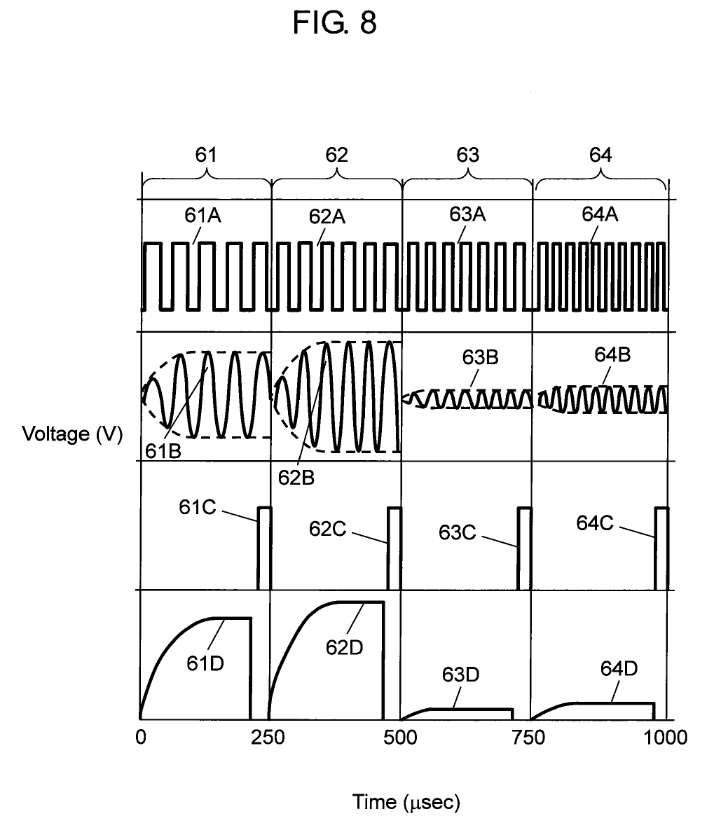

Next, with reference to FIG. 8, the switching by first switching part 91 and information waveforms outputted from sensors 25, 26 by this switching are described. FIG. 8 shows the waveforms shown in FIG. 7 in an expanded manner. A full span of a horizontal axis indicates time of 1 msec. First switching part 91 divides this 1 msec into four time zones 61 to 64 of 250 μsec. Second switching part 92 switches outputs from sensors 25, 26 to shaping part 94 in conjunction with first switching part 91. First switching part 91 and second switching part 92 repeat a series of operation in time zones 61 to 64, by which control part 95 continuously takes in the outputs of sensors 25, 26 through shaping part 94 sequentially.

That is, in time zone 61, coils 42A, 42B of sensor 25 are connected in series and in phase, so that the characteristics of the material of coin 20 are mainly sensed. In time zone 62, coils 42A, 42B of sensor 25 are connected in series and in reversed phase, so that the irregularity of coin 20 is mainly sensed.

In time zone 63, coils 44A, 44B of sensor 26 are connected in series and in phase, so that the characteristics of the material of coin 20 are mainly sensed. In time zone 64, coils 44A, 44B of sensor 26 are connected in series and in reversed phase, so that the thickness of coin 20 is mainly sensed.

As described above, control part 95 can receive two pieces of information per sensor at the same point of coin 20 by an action of first switching part 91. Thereby, a number of required types of information can be acquired even if the sensors are reduced in number, and uniformity in position where the information is acquired is improved, so that discrimination precision is enhanced. In a case where four types of information are acquired within 1 msec as described above, a speed at which coin 20 passes through passage 24 is about 0.2 m/sec and thus, positions of coin 20 where these types of information are acquired are within a range of 0.2 mm. Moreover, since shaping part 94 can be shared by providing second switching part 92, a circuit configuration can be simplified, contributing to cost reduction.

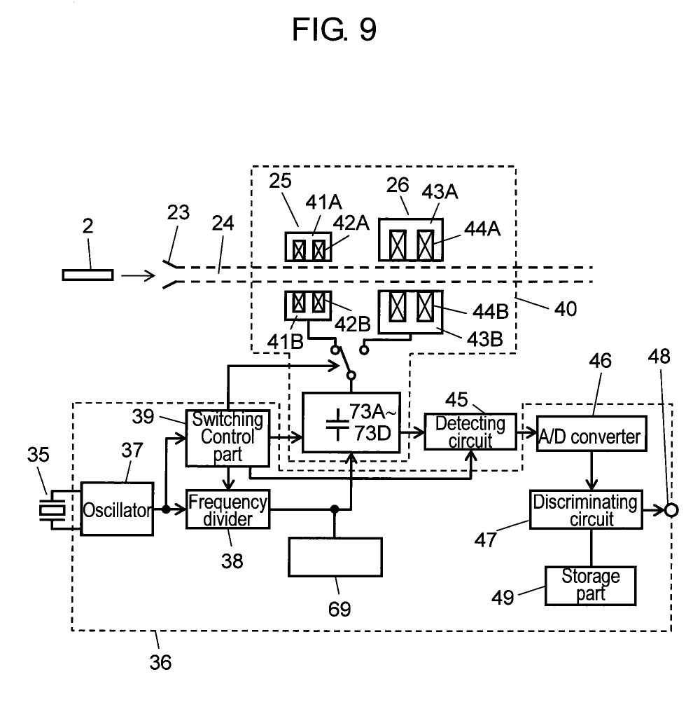

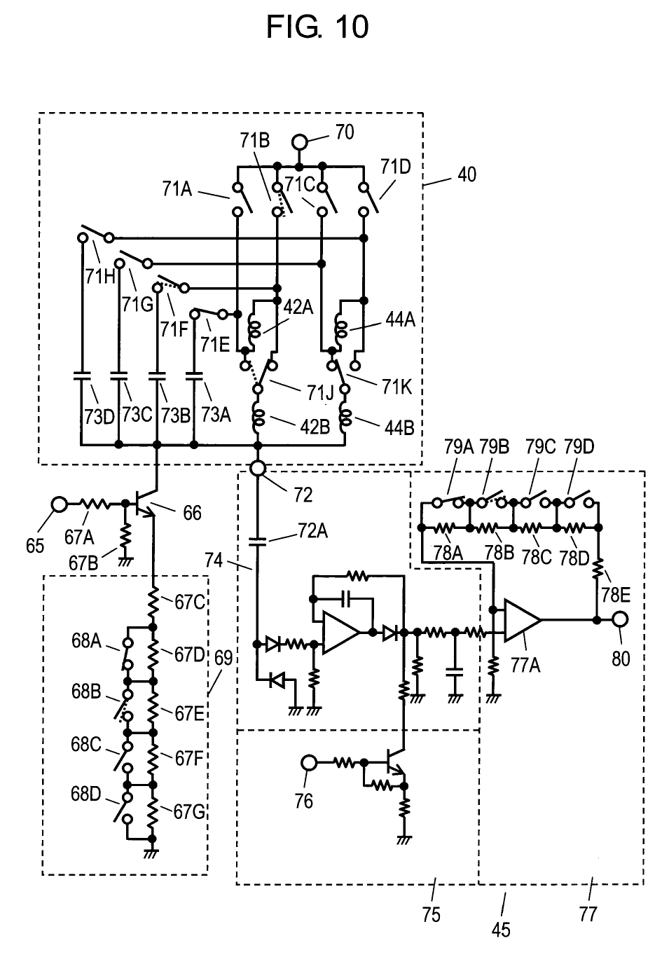

Next, an example of a specific circuit configuration and operation thereof are described with reference to FIGS. 8 to 10. FIG. 9 is a specific block diagram of coin discriminating device 21. FIG. 10 is a circuit diagram of tuning circuit 40, detecting circuit 45 and vicinity thereof in FIG. 9.

In FIG. 9, crystal oscillating element 35 oscillates, for example, at 8 MHz, and is connected to oscillator 37 inside microcomputer 36. A clock signal is outputted from oscillator 37, and this clock signal is connected to frequency divider 38 and switching control part 39. That is, crystal oscillating element 35, oscillator 37, and frequency divider 38 make up oscillating circuit 90 in FIG. 2. Oscillating circuit 90 is a separately-excited oscillating circuit that separately oscillates tuning circuit 40 described later at a predetermined frequency regardless of inductance values of sensors 25, 26.

An output of frequency divider 38 is connected to tuning circuit 40 including sensors 25, 26. Coils 42A, 42B, 44A, 44B are connected to capacitors 73A to 73D to make up tuning circuit 40. That is, tuning circuit 40 and switching control part 39 make up detecting part 96, first switching part 91 and second switching part 92 in FIG. 2. The connection inside tuning circuit 40 is electronically switched by an output of switching control part 39. Moreover, a frequency division ratio of frequency divider 38 is switched based on the output of switching control part 39.

An output of tuning circuit 40 is inputted to detecting circuit 45. Detecting circuit 45 incorporates a wave-detecting circuit, a peak-hold circuit, and a reset circuit that resets this peak-hold circuit. The reset circuit in detecting circuit 45 is reset by the output of switching control part 39. An output of detecting circuit 45 is connected to discriminating circuit 47 through analog/digital converter (A/D converter) 46. The peak-hold circuit and the reset circuit of detecting circuit 45, and A/D converter 46 shape the detection signal from tuning circuit 40 to output an envelope waveform to discriminating circuit 47. These make up shaping part 94 in FIG. 2.

An output of discriminating circuit 47 is connected to output terminal 48. Data indicating the authentication and the denomination of dropped coin 20 is outputted from output terminal 48. That is, discriminating circuit 47 and switching control part 39 make up control part 39 in FIG. 2. Offset switching circuit 69 connected between frequency divider 38 and tuning circuit 40 will be described later.

Next, referring again to FIG. 8, the respective outputs from frequency divider 38, tuning circuit 40, switching control part 39, and detecting circuit 45 and relations therebetween are described. The frequency division ratio of frequency divider 38 is switched by switching control part 39. Frequency divider 38 outputs signals 61A to 64A of different frequencies. In time zone 61, frequency divider 38 switches the frequency division ratio so that signal 61A of 100 kHz is outputted to coils 42A, 42B, for example.

Similarly, in time zone 62, frequency divider 38 switches the frequency division ratio to output signal 62A of 120 kHz, for example, to coils 42A, 42B. In time zone 63, frequency divider 38 switches the frequency division ratio to output signal 63A of 170 kHz, for example, to coils 44A, 44B, and in time zone 64, outputs signal 64A of 215 kHz, for example, to coils 44A, 44B.

Upon receiving signals 61A to 64A, tuning circuit 40 outputs signals 61B to 64B in time zones 61 to 64, respectively. As shown in the figure, it takes about 100 μsec for the operation of tuning circuit 40 to become stable, and for the output to become substantially constant.

Switching control part 39 outputs reset signals 61C to 64C of 50 μsec at an end of each of time zones 61 to 64. Based on these reset signals, the peak-hold circuit in detecting circuit 45 is reset.

Detecting circuit 45 detects signals 61B to 64B outputted from tuning circuit 40 to peak-hold the same, and outputs signals 61D to 64D. Detecting circuit 45, having the reset circuit, performs reset using reset signals 61C to 64C at the end of each of time zones 61 to 64 to prevent influence of a previous time of being exerted. A/D converter 46 converts signal 61D to 64D to digital amounts and supplies them to discriminating circuit 47.

Time when coin 20 passes through sensors 25, 26 is about 100 msec, respectively. Accordingly, each of sensors 25, 26 sequentially extracts the characteristics at 100 different points for one coin 20. In the present embodiment, the switching between the in-phase connection and the reversed phase connection, and the switching between sensors 25, 26 are performed by switching control part 39 so that 400 pieces of characteristic data are acquired within 100 msec. That is, switching is performed 400 times by switching control part 39 (100 points×2×2). Thus, since switching control part 39 performs the switching frequently, discriminating circuit 47 can acquire the characteristic data necessary for discrimination of coin 20 without adjusting timing when coin 20 is dropped and reaches sensors 25, 26. That is, switching control part 39 and discriminating circuit 47 need not be in conjunction with each other.

In the present embodiment, the irregularity and the material of coin 20 are sensed by sensor 25, and the thickness and the material of coin 20 are sensed by sensor 26 to precisely discriminate coin 20. However, even only one sensor allows the irregularity or thickness and material of coin 20 to be discriminated by switching this sensor between the in-phase connection and the reversed-phase connection. Hereinafter, a number of times of switching required when one sensor is used is described.

If the switching by switching control part 39 is slow, the precise characteristics of coin 20 cannot be sensed. With at least one sensor, the characteristics of coin 20 at 5 or more different points need to be acquired. Furthermore, considering the switching between the in-phase connection and the reversed-phase connection, 10 or more times of switching within the passage time of coin 20 are required. Moreover, the faster the switching by switching control part 39 is, the more precise sensing information can be acquired. However, making the switching faster than needed will place a burden to microcomputer 36. In view of the foregoing, it is preferable that the switching of switching control part 39 is set to 10 to 1000 times with one sensor.

Next, with reference to FIG. 10, more specific circuit configuration is described. Tuning circuit 40 is connected between a collector of transistor 66 and power source 70. Input terminal 65 is connected to the output of frequency divider 38, and is connected to a base of transistor 66 through resistor 67A. Resistor 67B is connected between the base of transistor 66 and a ground, and offset switching circuit 69 is connected to an emitter of transistor 66. The output of tuning circuit 40 is inputted to detecting circuit 45 through terminal 72.

Next, tuning circuit 40 is described. A first terminal of each of switches 71A to 71D is connected to power source 70. A second terminal of switch 71A is connected to a first terminal of switch 71E, a first selection terminal of switch 71J, and a second terminal of coil 42A. A common terminal of switch 71J is connected to a second terminal of coil 42B, and a first terminal of the coil 42B is connected to terminal 72 which is connected to the collector of transistor 66. Moreover, a second terminal of switch 71E is connected to terminal 72 through capacitor 73A.

A second terminal of switch 71B is connected to a first terminal of coil 42A, a second selection terminal of switch 71J, and a first terminal of switch 71F. A second terminal of switch 71F is connected to terminal 72 through capacitor 73B.

A second terminal of switch 71C is connected to a first terminal of switch 71G, a first selection terminal of switch 71K, and a second terminal of coil 44A. A common terminal of switch 71K is connected to a second terminal of coil 44B, and a first terminal of coil 44B is connected to terminal 72. Moreover, a second terminal of switch 71G is connected to terminal 72 through capacitor 73C.

A second terminal of switch 71D is connected to a first terminal of coil 44A, a second selection terminal of switch 71K and a first terminal of switch 71H. Moreover, a second terminal of switch 71H is connected to terminal 72 through capacitor 73D.

Switches 71A to 71D, switches 71E to 71H, and switches 71J, 71K are sequentially switched by switching control part 39 in accordance with time zones 61 to 64 shown in FIG. 8. More specifically, in time zone 61, switch 71A and switch 71E are shunted, and switch 71J is switched to the second selection terminal side. This allows coil 42A and coil 42B to be connected in series and in phase. Capacitor 73A is connected in parallel to a series connected unit of coil 42A and coil 42B.

In time zone 62, switch 71B and switch 71F are shunted, and switch 71J is switched to the first selection terminal side. This allows coil 42A and coil 42B to be connected in series and in reversed phase. Capacitor 73B is connected in parallel to a series connected unit of coil 42A and coil 42B.

In time zone 63, switch 71C and switch 71G are shunted, and switch 71K is switched to the second selection terminal side. This allows coil 44A and coil 44B to be connected in series and in phase. Capacitor 73C is connected in parallel to a series connected unit of coil 44A and coil 44B.

In time zone 64, switch 71D and switch 71H are shunted, and switch 71K is switched to the first selection terminal side. This allows coil 44A and coil 44B to be connected in series and in reversed phase. Capacitor 73D is connected in parallel to a series connected unit of coil 44A and coil 44B.

In switches 71A to 71D, only one selected switch is turned on, and the other switches are turned off as well as in switches 71E to 71H. In this manner, switches 71A, 71B, 71J make up first switching part 91 for sensor 25 in FIG. 2. Switches 71C, 71D, 71K make up first switching part 91 for sensor 26 in FIG. 2. Switches 71E, 71F make up third switching part 93 for sensor 25, and switches 71G, 71H make up third switching part 93 for sensor 26.

Moreover, switching control part 39 switches sensor 25 and sensor 26 with respect to detecting circuit 45 within 1 msec. That is, switches 71A, 71B, 71C, 71D make up second switching part 92 in FIG. 2.

The first terminal of each of switches 71A to 71D is directly connected to power source 70. That is, first switching part 91 has a pair of switches 71A, 71B and switch 71J for sensor 250. The pair of switches 71A, 71B is connected between sensor 25 and power source 70. Thereby, first switching part 91 can perform switching without exerting a harmful influence of high frequency on tuning circuit 40. From a different view point, second switching part 92 is provided between power source 70 and sensors 25, 26. Thereby, second switching part 92 can also perform switching without exerting a harmful influence of high frequency on tuning circuit 40.

In the circuit diagram of FIG. 10, the connection between power source 70 and coils 42A, 44A is switched by switches 71A to 71D provided outside the parallel circuit made up of coils and capacitors. In a parallel circuit of coils 42A, 42B and either of capacitors 73A, 73B, a pair of switch 71E, 71F and switch 71J are provided. On the other hand, in a parallel circuit of coils 44A, 44B and either of capacitors 73C, 73D, a pair of switches 71G, 71H, and switch 71K are provided. Such a simple configuration enables switching including capacitors 73A to 73D, and the functions of first switching part 91 and second switching part 92 to be realized. A smaller resistance value included in each of the parallel circuits made up of the coils and one of the capacitors is more preferable. Therefore, it is preferable that in this manner, the number of switches is made small to make up the circuit.

Moreover, since capacitors 73A to 73D forming tuning circuit 40 are provided independently of each other, frequency adjustment of the series in-phase connection and that of the series reversed-phase connection can be performed easily.

The output of tuning circuit 40 is outputted to terminal 72 and is inputted to detecting circuit 45. The output of detecting circuit 45 is outputted from terminal 80 to A/D converter 46. Detecting circuit 45 is made up of peak-hold circuit 74, reset circuit 75, input terminal 76, and gain switching circuit 77. Peak-hold circuit 74 is connected to terminal 72, and includes a publicly known detector circuit. Reset circuit 75 resets peak-hold circuit 74. Through input terminal 76, the reset signal is inputted from switching control part 39 to reset circuit 75. Gain switching circuit 77 is provided between an output end of peak-hold circuit 74 and terminal 80.

Gain switching circuit 77 is made up of resistors 78A to 78D connected in series between an input and an output of operational amplifier 77A, and switches 79A to 79D connected to resistors 78A to 78D in parallel, respectively. Switching parts 79A to 79D are switched by switching control part 39 corresponding to the respective time zones 61 to 64 shown in FIG. 8. Gain switching circuit 77 switches ON and OFF of switches 79A to 79D so as to maximize a variation width of a gain in each of the outputs of sensors 25, 26. This increases an S/N ratio of each of signals 61D to 64D so as to enhance measurement precision.

Gain switching circuit 77 shown in FIG. 10 is made up of resistors 78A to 78D, and switches 79A to 79D connected to resistors 78A to 78D in parallel, respectively. Alternatively, resistors 78A to 78D may be connected in parallel, and switches 79A to 79D may be connected to resistors 78A to 78D in series respectively to make up gain switching circuit 77.

Next, offset switching circuit 69 is described. Offset switching circuit 69 is made up of resistors 67C, 67D, 67E, 67F, 67G, and switches 68A to 68D. Resistors 67C, 67D, 67E, 67F, 67G are connected between the emitter of transistor 66 and a ground in series. Each of switches 68A to 68D is connected to both ends of each of resistors 67D to 67G. Switches 68A to 68D are switched by switching control part 39 in accordance with time zones 61 to 64 shown in FIG. 8, and give an offset voltage determined in advance for each of the above-described switching to an output voltage of detecting circuit 45. That is, offset switching circuit 69 controls the offset voltage by switching switches 68A to 68D so as to increase an output voltage variation width of detecting circuit 45. This increases the S/N ratio of each of signal 61D to 64D, and enhances measurement precision.

In offset switching circuit 69 shown in FIG. 10, resistors 67D to 67G are connected in series, and respective resistors 67D to 67G and respective switches 68A to 68D are connected in parallel. Alternatively, resistors 67D to 67G are connected in parallel, and respective resistors 67D to 67G may be connected to respective switches 68A to 68D in series. Moreover, zener diodes different in zener voltage may be inserted into an input of peak-hold circuit 74 in parallel, and these zener diodes may be switched by an electronic switch to thereby switch the offset voltage.

As described above, it is important for performing precise measurement to maximize the variation width of the gain in each of the outputs of sensors 25, 26 by gain switching circuit 77 and offset switching circuit 69.

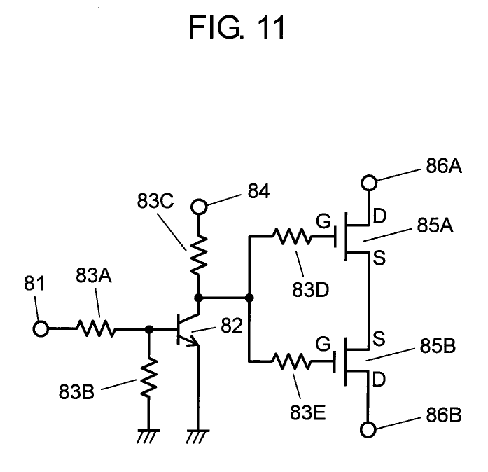

Next, a preferable configuration of each of switches 71A to 71K is described. FIG. 11 is a circuit diagram showing either of switches 71A to 71K used in the present embodiment. Particularly, for each of switches 71E to 71K used in tuning circuit 40, it is preferable to use an electronic switch in a form using field-effect transistors (FET). That is, it is preferable that each of first switching part 91 and second switching part 92 is made up of a plurality of FETs that are switching elements. This is to enhance isolation of tuning circuit 40 in switching the frequency. This configuration can also be used for switches 68A to 68D and switches 79A to 79D.

A signal controlled by switching control part 39 is inputted to input terminal 81. Resistor 83A is connected between input terminal 81 and a base of transistor 82. Resistor 83B is connected between the base of transistor 82 and a ground. An emitter of transistor 82 is directly connected to a ground, and a collector is connected to power source 84 of 24 V, for example, through resistor 83C.

Moreover, the collector of transistor 82 is connected to a gate of N channel FET 85A through resistor 83D. The collector of transistor 82 is also connected to a gate of N channel FET 85B through resistor 83E. A drain of FET 85A is connected to first terminal 86A, and a source of FET 85A is connected to a source of FET 85B. A drain of FET 85B is connected to second terminal 86B.

In this manner, two FETs 85A, 85B are connected in series. This enhances isolation between terminals 86A, 86B, and improves high-frequency performance. Moreover, since each of switches 71E to 71K is made up of FET 85A, 85B, an on-resistance can be made extremely small. Each of switches 71J, 71K in tuning circuit 40 only needs to have two electronic switches shown in FIG. 11.

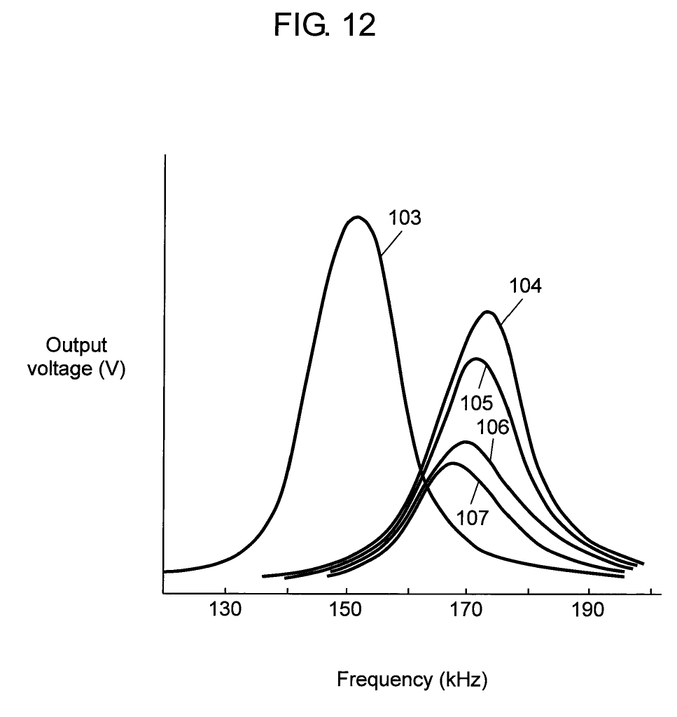

Next, a principle to acquire different pieces of information of coin 20 by switching the magnetic connection of two opposed coils 44A, 44B in sensor 26 is described. FIG. 12 shows output properties of tuning circuit 40 when coils 44A and 44B are connected in series and in phase, and coins 20 having the same thickness but different materials are dropped, that is, it shows variations in output voltage with respect to frequency.

Characteristic curve 103 is outputted at the time of no loading when no metal exists in the vicinity of coils 44A, 44B. A center frequency thereof is about 150 kHz. Characteristic curves 104 to 107 are outputted at the time of loading when metal exists in the vicinity of coils 44A, 44B. A central frequency thereof is about 170 kHz. Characteristic curve 104 shows a property in a case where copper is used as loading metal making coin 20, and characteristic curve 105 shows a property in a case where brass is used as loading metal. Characteristic curve 106 shows a property in a case where white copper is used as loading metal, and characteristic curve 107 shows a property in a case nickel is used as loading metal. As shown in the figure, the characteristic curves show levels characterized by metallic species as the loading. Accordingly, the material of dropped coin 20 can be sensed using these characteristics of the level.

The center frequency of tuning circuit 40 is higher by about 20 kHz at the time of loading as compared with that at the time of no loading. Accordingly, if an output frequency outputted from frequency divider 38 is set to be higher by 20 kHz as compared with the center frequency at the time of no loading, the material of coin 20 can be sensed with a high sensitivity. Moreover, by setting this setting frequency to be slightly higher than a peak frequency at the time of loading, stability becomes favorable. That is, it is preferable that an oscillation frequency of oscillating circuit 90 when coils 44A, 44B are connected in phase is set to be away by a predetermined frequency (e.g., 20 kHz) from a tuning frequency before coin 20 passes between coils 44A, 44B.

A peak frequency at the time of no loading is detected by switching control part 39 (control part 95) measuring the output of A/D converter 46 while varying the frequency by varying the frequency division ratio of frequency divider 38. This detected value is stored in storage part 49 in microcomputer 36. Frequency divider 38 switches the frequency division ratio so that the frequency stored in storage part 49 is set when coin 20 is not dropped to thereby correct the oscillation frequency. Since in this manner, variation with time and variation in temperature are corrected, coin 20 can be precisely discriminated even when circumstances are changed.

Moreover, by detecting the peak frequency at the time of no loading is detected for each product at production time and storing the same in storage part 49 of each of the product, the output frequency of oscillator 37 can be optimized. Therefore, high discrimination performance that is not affected by variations in respective products can be achieved.

Moreover, while after shipment, switching control part 39 (control part 95) also detects the peak frequency when coin 20 is not dropped, this measurement range can be limited to a relatively narrow range (narrower range than that at the production time) centering around the peak frequency stored for each of the product at the production time. This can shorten a detection time of the peak frequency.

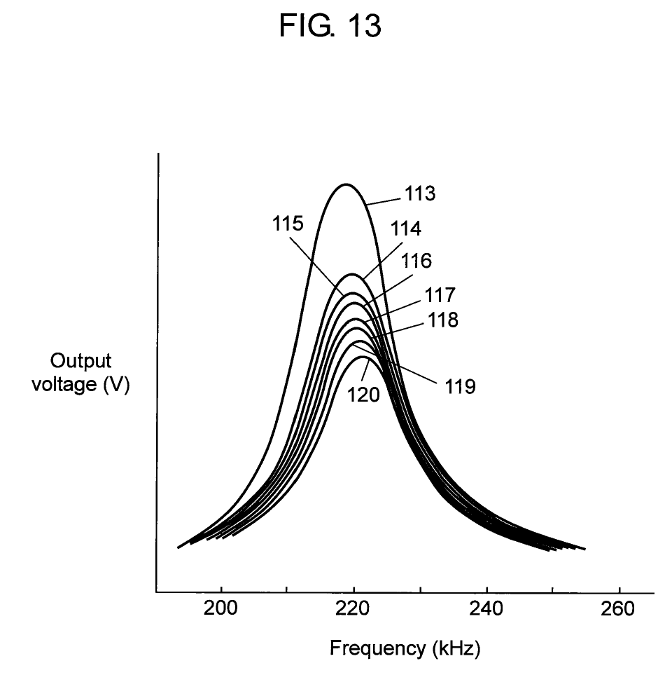

FIG. 13 shows output properties of tuning circuit 40 when coils 44A, 44B are connected in series and in reversed phase, and coins 20 made of the same material and having different thicknesses are dropped. Characteristic curve 113 is outputted at the time of no loading when no metal exists in the vicinity of coils 44A, 44B. Moreover, characteristic curves 114 to 120 are outputted at the time of loading when metal exists in the vicinity of coils 44A, 44B. In either case, a central frequency is about 215 kHz. In characteristic curve 114 at the time of loading, there arises a loss caused by an eddy current of about 0.8 V, as compared with characteristic curve 113 at the time of no loading. This decreases a voltage level. Moreover, as shown in characteristic curves 114 to 120, a magnitude of the loss differs depending on the thickness of the metal. That is, as the thickness increases from characteristic curve 114 of a thin metal, changes from characteristic curves 115 to 120 are exhibited. Accordingly, these characteristics of the level can be used to sense the thickness of dropped coin 20. Therefore, it is preferable that the oscillation frequency when coils 44A, 44B are connected in reversed phase is set to substantially the same frequency as a tuning frequency before coin 20 passes between coils 44A, 44B.

With the setting of this frequency, an optimal frequency for each product is set. Moreover, while in FIGS. 12 and 13, sensor 26 is described, a similar principle is applied to sensor 25. However, since sensor 25 has a smaller diameter than sensor 26, lines of magnetic force 50B in FIG. 4 do not spread in a surface direction of coin 20. Therefore, when coils 42A, 42B are connected in reversed phase, information in which irregularity of a relatively minute area on a surface of coin 20 is reflected can be acquired.

As described above, in coin discriminating device 21, the output of oscillator 37 is supplied to tuning circuit 40 through frequency divider 38, and oscillator 37 is provided independently of tuning circuit 40. Thus, even if impedances of coils 42A, 42B, 44A, 44B are varied by an influence of coin 20, or an environmental influence such as ambient temperature, the oscillation frequency of oscillator 37 is not affected, so that coin 20 can be discriminated stably.

### Second Exemplary Embodiment

In the first exemplary embodiment, the principle for discriminating the material of coin 20 made of a single material is described. In the present embodiment, a principle for discriminating materials of coin 20A made of a clad material of two or more species of metal, and a corresponding configuration are described.

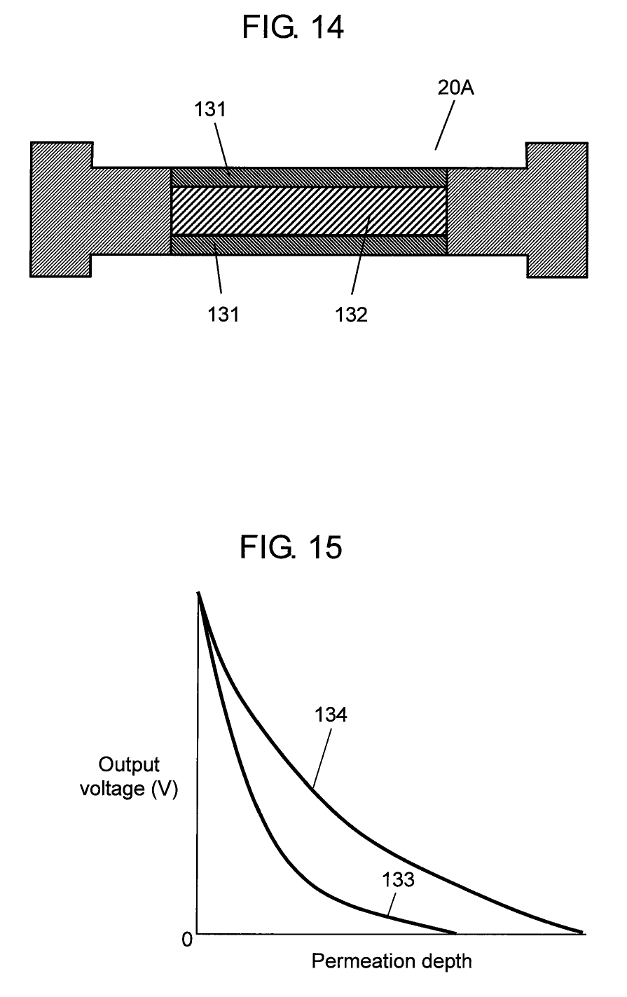

FIG. 14 is a cross-sectional diagram of coin 20A constructed as described above. For example, surface material 131 is white copper, and core material 132 is copper. That is, coin 20A is, for example, 10, 25, and 50 cents of United States.

As shown in FIG. 12, output properties of tuning circuit 40 vary depending on the coin material. While differences in output property in a case of the same material and the different coin thicknesses are shown in FIG. 13, in a case of the different coin materials, the output voltage also differs. This difference in output voltage can be utilized to discriminate surface material 131 from core material 132.

FIG. 15 is a property diagram showing variations in output voltage of tuning circuit 40 with respect to a depth from a top surface of coin 20A shown in FIG. 14. Characteristic curve 133 shows a case where a signal of an oscillation frequency higher than that of characteristic curve 134 is inputted to tuning circuit 40. At this time, coils 44A, 44B are connected in reversed phase.

When created AC magnetic fields of coil 44A, 44B permeate coin 20A in a thickness direction thereof, a permeation depth differs depending on the frequency. More specifically, in high frequencies, the magnetic fields do not permeate deeply due to skin effects, so that an influence of surface material 131 is large. While in low frequencies, the magnetic fields permeate deeply, so that surface material 131 and core material 132 affect the output voltage level. Accordingly, based on a difference in output level by surface material 131 and core material 132, coin 20A can be discriminated.

More specifically, in FIG. 10, two types of different frequencies switched by switching control part 39 are alternately inputted from frequency divider 38 to input terminal 65. If the material of surface material 131 and the material of core material 132 making up coin 20A are different, the output levels in tuning circuit 40 in these inputted frequencies differ. Therefore, for example, a difference in output voltage between at the time of no loading and at the time of loading when a signal of 100 kHz is inputted from input terminal 65 and a difference in output voltage between at the time of no loading and at the time loading when a signal of 200 kHz is inputted are detected. Values obtained in a case of known coin 20A are stored in storage part 49 in advance, and the detected differences are compared with the stored values by discriminating circuit 47 (control part 95). This allows the materials of coin 20A to be discriminated. In this manner, using one sensor 26, the materials of coin 20A can be sensed by switching the applied frequency.

### Third Exemplary Embodiment

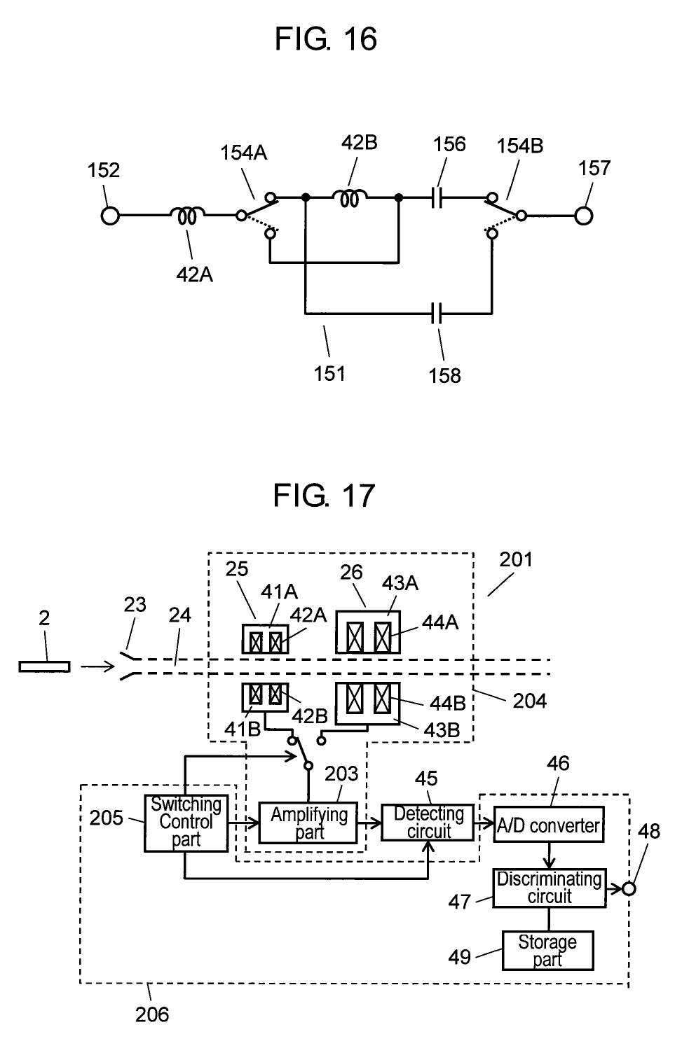

FIG. 16 is a circuit diagram showing a part of a tuning circuit in the present embodiment. In the first exemplary embodiment, sensors 25, 26 and capacitors 73A to 73D are connected in parallel in tuning circuit 40. In the present embodiment, sensors 25, 26, and capacitors 156 and 158 are connected in parallel to make up the tuning circuit. More specifically, the present exemplary embodiment is different from the first exemplary embodiment in that the series tuning circuit is used, and the tuning circuit in which circuit 151 and a circuit having a similar configuration to that of circuit 151 are connected in series is used in place of tuning circuit 40 in FIG. 10. Circuit 151 shows only a part including sensor 25.

Circuit 151 is inserted between the collector of transistor 66 and terminal 72 of detecting circuit 45 in FIG. 10. In this case, since this is a series tuning circuit, coupling capacitor 72A connected to terminal 72 of detecting circuit 45 can be omitted.

Hereinafter, a configuration of circuit 151 is described. First terminal 152 of circuit 151 is connected to the first terminal of coil 42A, and the second terminal of coil 42A is connected to a common terminal of switch 154A. A first selection terminal of switch 154A is connected to the first terminal of coil 42B, and the second terminal of coil 42B is connected to a first selection terminal of switch 154B through capacitor 156. Moreover, a common terminal of switch 154B is connected to second terminal 157 of circuit 151. A second selection terminal of switch 154A is connected to the second terminal of coil 42B, and the first terminal of coil 42B is connected to a second selection terminal of switch 154B through capacitor 158.

Switches 154A, 154B are configured similarly to switches 71J, 71K of the first exemplary embodiment. Moreover, capacitors 156, 158 forming circuit 151 are provided independently of each other. This allows frequency adjustment of the series in-phase connection and that of the series reversed-phase connection to be performed easily.

Operation of circuit 151 configured as above is described. Switches 154A, 154B are switched in a direction indicated by a solid line by the output of switching control part 39 in FIG. 9. Thus, coils 42A, 42B are connected in series and in phase, and capacitor 156 is connected in series to this series connected unit. Since coils 42A, 42B are connected in series and in phase, the material of coin 20 can be sensed efficiently.

Moreover, when switches 154A, 154B are switched in a direction indicated by a dashed line by the output of switching control part 39, coils 42A, 42B are connected in series and in reversed phase. Simultaneously, capacitor 158 is connected in series to this series connected unit. Since coils 42A, 42B are connected in series and in reversed phase, the thickness of coin 20 can be sensed efficiently.

Since circuit 151 is a series tuning circuit, a Q value, which is a value indicating a degree of resonance sharpness of a resonance circuit, is large. The Q value in the series tuning circuit is expressed by an inverse value of a product of R, ω and C, where R is an internal resistance included in the tuning circuit, C is a capacitance, and ω is an angular frequency. Moreover, a use of circuit 151 allows first switching part 91 or third switching part 93 in FIG. 2 to be made up of only switches 154A, 154B.

### Fourth Exemplary Embodiment

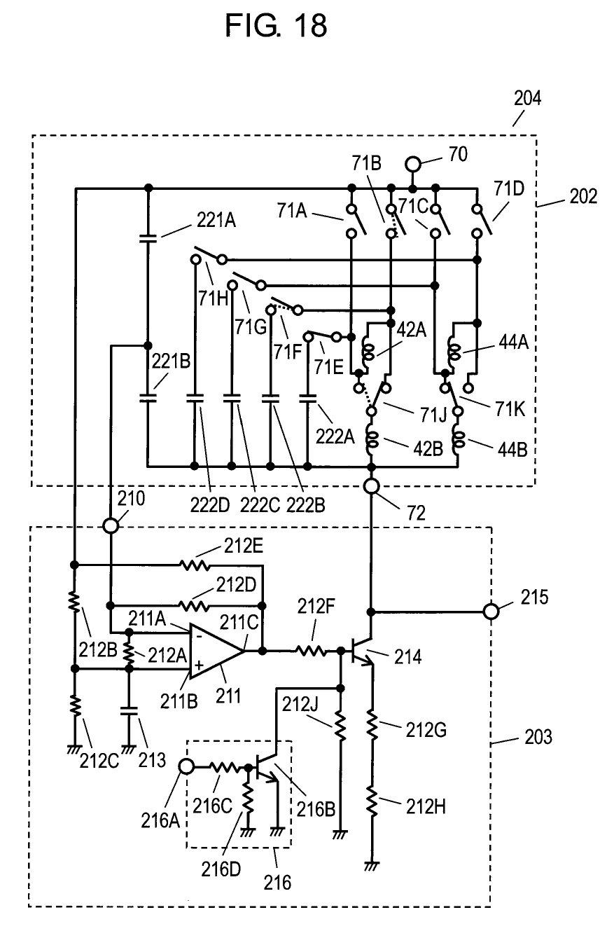

FIG. 17 is a block diagram focusing on electric circuitry of coin discriminating device 201 in a fourth exemplary embodiment. FIG. 18 is a circuit diagram of oscillating part 204 in FIG. 17. While a basic configuration is similar to that of FIG. 2 in the first exemplary embodiment, a configuration of oscillating circuit 90 is different in the present embodiment. More specifically, in the first exemplary embodiment, the output of oscillator 37 that oscillates at a fixed frequency is supplied to tuning circuit 40 through frequency divider 38. In contrast, a self-excited oscillating circuit including tuning circuit 202 of a variable tuning frequency is used in the present embodiment.

As is evident from comparison between FIGS. 17 and 9, in this configuration, switching control part 205 and oscillating part 204 are provided in place of switching control part 39, tuning circuit 40, crystal oscillating element 35, oscillator 37, and frequency divider 38. Switching control part 205 corresponds to switching control part 39, and switches the connections in oscillating part 204, and switches a gain of detecting circuit 45. An output of oscillating part 204 is connected to detecting circuit 45. Switching control part 205, A/D converter 46, and discriminating circuit 47 are configured by microcomputer 206, and data indicating authentication and a denomination of dropped coin 20 is outputted from output terminal 48. That is, in this configuration, oscillating part 204 serves as detecting part 96 in FIG. 2.

As shown in FIG. 18, oscillating part 204 is made up of tuning circuit 202 and amplifying part 203 for oscillation. Tuning circuit 202 is formed of sensors 25, 26, and capacitors 221A, 221B, 222A to 222D connected in parallel to sensors 25, 26. That is, oscillating part 204 performs self-exited oscillation. Details of oscillating part 204 will be described later.

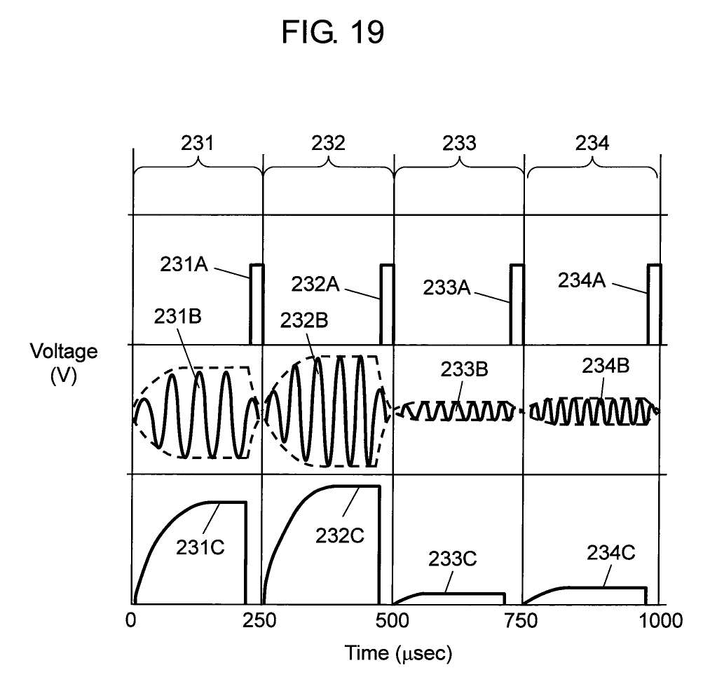

Next, referring to FIG. 19, switching by switching control part 205, and waveforms of signals outputted from sensors 25, 26 by this switching are described. Switching control part 205 divides 1 msec into four time zones 231, 232, 233, 234 at even intervals. Switching control part 205 repeats a series of time of time zones 231 to 234, by which detecting circuit 45 continuously takes in the outputs of sensors 25, 26 sequentially.

In time zone 231, coils 42A, 42B of sensor 25 are connected in series and in phase, so that the characteristics of the material of coin 20 are mainly sensed. In time zone 232, coils 42A, 42B of sensor 25 are connected in series and in reversed phase, so that the irregularity in the surfaces of coin 20 is mainly sensed.

In time zone 233, coils 44A, 44B of sensor 26 are connected in series and in phase, so that the characteristics of the material of coin 20 are mainly sensed. In time zone 234, coils 44A, 44B of sensor 26 are connected in series and in reversed phase, so that the thickness of coin 20 is mainly sensed.

Switching control part 205 outputs reset signals 231A to 234A of 50 μsec at an end of each of time zones 231 to 234. As shown in FIG. 18, reset circuit 216 is provided in amplifying part 203. Moreover, as described in the first exemplary embodiment, peak-hold circuit 74 is provided in detecting circuit 45. Switching control part 205 resets reset circuit 216 and peak-hold circuit 74 by reset signals 231A to 234A.

Oscillating part 204 outputs signals 231B to 234B in each of time zones 231 to 234. It takes about 100 μsec for the output of oscillating part 204 to be stable and substantially constant. Oscillating part 204 is reset by reset circuit 216 at the end of each of time zones 231 to 234 to prevent influence on the subsequent time.

The time until the output of oscillating part 204 becomes stable can be shortened by using a stabilizing part. If the time until the output of oscillating part 204 becomes stable is shortened, the in-phase connection and the reversed-phase connection of sensors 25, 26 can be switched more frequently, so that the uniformity in measurement position can be further improved.

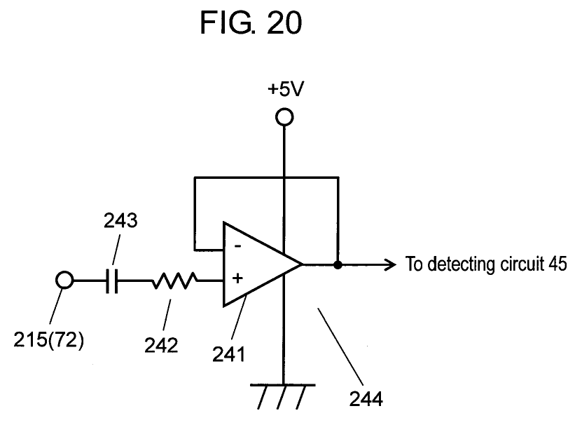

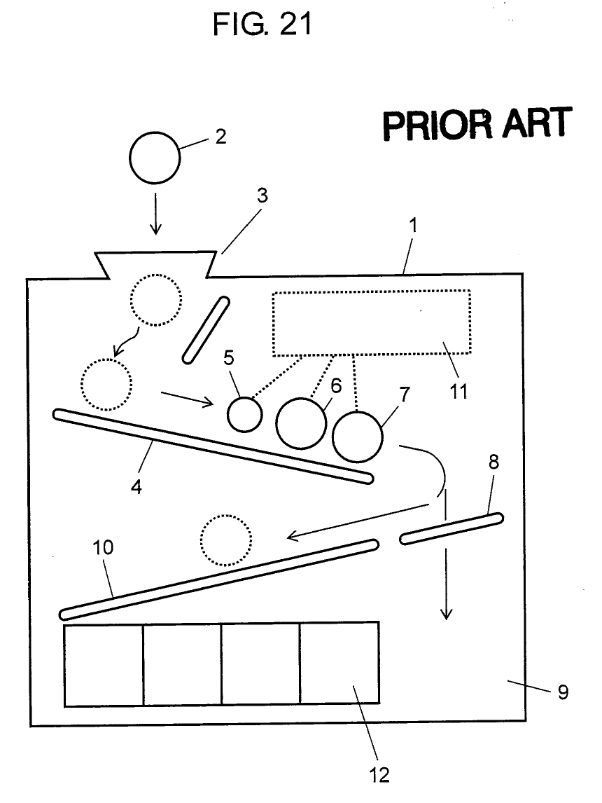

As a specific example of the stabilizing part, it can be realized by providing a buffer circuit using an operational amplifier between output terminal 215 of tuning circuit 202 and detecting circuit 45. FIG. 20 is a circuit diagram showing one example of the buffer circuit. Output terminal 215 is connected to a plus input terminal of operational amplifier 241 through capacitor 243 and resistor 242. Moreover, a minus input terminal of operational amplifier 241 is connected to an output side of operational amplifier 241. Such a voltage follower 244 can be used as the buffer circuit. Such a buffer circuit may be used in the first exemplary embodiment. That is, voltage follower 244 may be inserted between connection terminal 72 and detecting circuit 45.

As another example of the stabilizing part, offset switching circuit 69 in FIG. 10 can be used. That is, offset switching circuit 69 is controlled by switching control part 205 so that an offset voltage is controlled only for first 50 μsec in each switching interval of 250 μsec to speed up a rise of the oscillation. More specifically, control over switches 68A to 68D of offset switching circuit 69 by switching control part 205 allows the stabilizing part to be realized. This control may be used in the first exemplary embodiment. That is, switches 68A to 68D may be controlled by switching control part 39 as described above.

Detecting circuit 45 detects signals 231B to 234B that oscillating part 204 outputs in respective time zones 231 to 234 and applies the peak hold to the same so as to output signals 231C to 234C. A detailed description of actions of detecting circuit 45 and the later, which are similar to those in the first exemplary embodiment, is not given.

Next, with reference to FIG. 18, a circuit configuration of oscillating part 204 is described. Oscillating part 204 has tuning circuit 202 and amplifying part 203 in positive feedback connection to tuning circuit 202.

First, amplifying part 203 is described. Input terminal 210 of amplifying part 203 is connected to minus input terminal 211A of comparator 211. Resistor 212A is connected between minus input terminal 211A and plus input terminal 211B. Resistors 212B and 212C are connected in series between power source 70 and a ground. A connection point thereof is connected to plus input terminal 211B so as to supply a reference voltage to plus input terminal 211B of comparator 211. Capacitor 213 is connected between plus input terminal 211B and the ground.

Feedback resistor 212D is connected between output terminal 211C and minus input terminal 211A of comparator 211, and pull-up resistor 212E is connected between output terminal 211C and power source 70. Moreover, resistor 212F is connected between output terminal 211C of comparator 211 and a base of NPN type transistor 214. Resistor 212J is connected between the base of transistor 214 and the ground. Resistors 212G and 212H are connected in series between an emitter of transistor 214 and the ground.

Resistor 212G is used for offset voltage adjustment, and an appropriate offset voltage is set by resistor 212G. In place of resistor 212G, offset switching circuit 69 shown in the first exemplary embodiment may be used.

A collector of transistor 214 is connected to terminal 72 and output terminal 215 of oscillating part 204. Moreover, reset circuit 216 is connected to a connection point between the base of transistor 214 and resistor 212F. In reset circuit 216, resistor 216C is connected between input terminal 216A and a base of NPN type transistor 216B, and resistor 216D is connected between the base of transistor 216B and the ground.

An emitter of transistor 216B is connected to the ground and a collector thereof is connected to the connection point between the base of transistor 214 and resistor 212F. Moreover, input terminal 216A of reset circuit 216 is connected to switching control part 205, and reset circuit 216 is reset at input timing of each of reset signals 213A to 234A. Accordingly, at this timing, the output of oscillating part 204 is stopped.

Next, tuning circuit 202 is described. Tuning circuit 202 is connected between terminal 72 and input terminal 210 and determines an oscillation frequency of oscillating part 204. Tuning circuit 202 is an almost similar circuit to tuning circuit 40 described in the first exemplary embodiment, and a description is given, focusing on differences.

In tuning circuit 202, capacitors 221A, 221B are connected in series between power source 70 and terminal 72. A connection point between capacitor 221A and capacitor 221B is connected to input terminal 210 of amplifying part 203. In this configuration, tuning circuit 202 is connected between an input of comparator 211 and the collector (output) of transistor 214 which make up amplifying part 203, thereby oscillating part 204 performs the self-excited oscillation.

Moreover, capacitor 222A is connected between the second terminal of switch 71E and terminal 72. Similarly, capacitor 222B is connected between the second terminal of switch 71F and terminal 72, and capacitor 222C is connected between the second terminal of switch 71G and terminal 72. Moreover, capacitor 222D is connected between the second terminal of switch 71H and terminal 72. Capacitors 222A to 222D correspond to capacitors 73A to 73D in the first exemplary embodiment, respectively.

A series unit of capacitors 221A, 221B is connected between power source 70 and terminal 72 in parallel. In order to correct a combined capacitance by addition of this series unit, capacitance values of capacitors 222A to 222D are smaller than those of capacitors 73A to 73D in the first exemplary embodiment. Accordingly, a tuning frequency is almost similar to that of tuning circuit 40 in the first exemplary embodiment.

Moreover, switching of switches 71A to 71K is performed by switching control part 205. This switching timing is similar to that of switching control part 39 described in the first exemplary embodiment.

As described above, switching control part 205 that switches the signal outputted from oscillating part 204 within a period of time when coin 20 passes through sensors 25, 26 a plurality of times is also provided in the present embodiment. Since switching control part 205 switches the signal outputted from oscillating part 204 at a high speed while coin 20 passes through sensors 25, 26, a correlation between a plurality types of characteristics at the same site of coin 20 can be detected. Accordingly, discriminating circuit 47 can perform precise discrimination of coin 20 including characteristics of the correlation at this same site.

Moreover, since using switching control part 205, sensors 25, 26 are switched between the in-phase connection for detecting the material of coin 20 and the reversed-phase connection for detecting the thickness of coin 20, coin discriminating device 201 can be downsized, and a reduction in price can be achieved. These effects are similar to the first exemplary embodiment.

Furthermore, in the present embodiment, since oscillating part 204 oscillating in a self-exited manner is provided, frequency divider 38 and the like can be omitted, which can realize a configuration with less components as compared with the first exemplary embodiment. Moreover, constant oscillation at the tuning frequency allows a stable tuning state to be kept, thereby enabling precise discrimination.

In the present embodiment, a similar configuration to third switching part 93 shown in FIG. 6 may be applied to any one or more of capacitors 71E to 71H, 221A, 221B so as to switch to a capacitor(s) different in capacitance from capacitors 71E to 71H, 221A, 221B. This changes the oscillation frequency of oscillating part 204, thereby bringing about similar effects to the second exemplary embodiment. The configuration in which the materials of coin 20A made of a plurality of metals are discriminated by changing the oscillation frequency in this manner may be applied to a coin discriminating device that does not perform magnetic connection switching of sensor 25 and sensor 26.

While in these embodiments, the envelope waveforms are formed in shaping part 94 (detecting circuit 45), the present invention is not limited thereto. For example, by detecting output voltages immediately before detecting circuit 45 is reset, or peak values of the output voltages in a measurement interval, coin 20 can be discriminated.

### INDUSTRIAL APPLICABILITY

Since a coin discriminating device according to the present invention can sense a correlation between a material and a thickness at almost the same site, thereby precisely discriminating a coin, it is usable as a coin discriminating device mounted on a vending machine or the like.

1. A coin discriminating device comprising:
a detecting part having a first sensor including a pair of coils and an oscillating circuit, the detecting part being supplied with voltage from a power source, and configured to output a detection signal varied by a coin passing between the pair of coils;
a first switching part configured to switch magnetic connection of the pair of coils a plurality of times between an in-phase connection and a reversed-phase connection while the coin passes between the pair of coils;
a storage part configured to store a reference signal; and
a control part configured to compare the detection signal and the reference signal, thereby determine authentication and a denomination of the coin.

2. The coin discriminating device according to claim 1, wherein the first switching part has two pairs of switches, and one of the switches is connected between the first sensor and the power source.

3. The coin discriminating device according to claim 1, wherein the detecting part further has a second sensor made up of a pair of coils.

4. The coin discriminating device according to claim 3, further comprising a second switching part configured to switch the detection signal by the first sensor, and a detection signal by the second sensor.

5. The coin discriminating device according to claim 4, wherein the second switching part is provided between the power source, and the first sensor and the second sensor.

6. The coin discriminating device according to claim 4, wherein the second switching part is made up of a plurality of switching elements.

7. The coin discriminating device according to claim 1, wherein the detecting part further has a capacitor connected to the first sensor.

8. The coin discriminating device according to claim 7, wherein the capacitor is connected to the first sensor in series.

9. The coin discriminating device according to claim 1, wherein the detecting part further has a plurality of capacitors, and
the coin discriminating device further comprises a third switching part configured to switch the plurality of capacitors to be connected to the first sensor.

10. The coin discriminating device according to claim 9, wherein the third switching part is made up of a plurality of switching elements.

11. The coin discriminating device according to claim 1, further comprising an offset switching circuit configured to switch offset voltages for offsetting the detection signal.

12. The coin discriminating device according to claim 1, wherein the oscillating circuit is configured to switch frequencies to oscillate.

13. The coin discriminating device according to claim 1, further comprising a gain switching circuit configured to vary a gain of the detecting part so as to switch a gain of the detection signal.

14. The coin discriminating device according to claim 1, wherein the oscillating circuit is a separately-excited oscillating circuit that oscillates at a predetermined oscillation frequency regardless of an inductance value of the first sensor.

15. The coin discriminating device according to claim 14, wherein the oscillation frequency of the oscillating circuit is set based on a tuning frequency before the coin passes between the pair of coils.

16. The coin discriminating device according to claim 15, wherein the oscillation frequency of the oscillating circuit when the pair of coils are connected in phase is set to be away from the tuning frequency before the coin passes between the pair of coils by a predetermined frequency.

17. The coin discriminating device according to claim 15, wherein the oscillation frequency of the oscillating circuit when the pair of coils are connected in reversed phase is set to a substantially identical frequency as the tuning frequency before the coin passes between the pair of coils.

18. The coin discriminating device according to claim 14, wherein the control part is configured to detect the tuning frequency before the coin passes between the pair of coils and correct the oscillation frequency of the oscillating circuit.

19. The coin discriminating device according to claim 18, wherein the oscillating circuit includes a frequency divider that is controlled by the control part and is configured to correct the oscillation frequency of the oscillating circuit.

20. The coin discriminating device according to claim 1, wherein the detecting part further has:
a capacitor connected to the first sensor and making up a tuning circuit together with the first sensor; and
an amplifying part connected to the tuning circuit, and making up the oscillating circuit together with the tuning circuit, and
the oscillating circuit is a self-excited oscillating circuit.

21. The coin discriminating device according to claim 1, further comprising a shaping part configured to shape the detection signal and output an envelope waveform to the control part.

22. The coin discriminating device according to claim 21, wherein the shaping part has a peak-hold circuit and a reset circuit configured to set the peak-hold circuit to an initial state.

23. The coin discriminating device according to claim 1, further comprising a stabilizing part configured to stabilize the output from detecting part to the control part.

24. The coin discriminating device according to claim 23, wherein the stabilizing part is formed of a buffer circuit connected between the detecting part and the control part.

25. The coin discriminating device according to claim 23, wherein the stabilizing part is formed of an offset switching circuit configured to speed up a rise of an oscillation amplitude of the oscillating circuit by switching offset voltages for offsetting the detection signal.

26. The coin discriminating device according to claim 1, wherein the first switching part is formed of a plurality of switching elements.
